(19) United States
(12) Patent Application Publication
(10) Pub. No.: US 2014/0192308 A1
(43) Pub. Date: Jul. 10, 2014

(54) LIQUID CRYSTAL DISPLAY

(71) Applicants: Tomoo Furukawa, Osaka-shi (JP); Yuhko Hisada, Osaka-shi (JP); Katsushige Asada, Osaka-shi (JP)

(72) Inventors: Tomoo Furukawa, Osaka-shi (JP); Yuhko Hisada, Osaka-shi (JP); Katsushige Asada, Osaka-shi (JP)

(73) Assignee: SHARP KABUSHIKI KAISHA, Osaka-shi, Osaka (JP)

(21) Appl. No.: 14/236,725

(22) PCT Filed: Aug. 3, 2012
(86) PCT No.: PCT/JP2012/069798

§ 371 Date: Feb. 3, 2014

(30) Foreign Application Priority Data
Aug. 10, 2011 (JP) 2011-175464

(51) Int. Cl. G02F 1/1343

(52) U.S. Cl. CPC G02F 1/134363
USPC 349/138

(57) ABSTRACT

The present invention provides a liquid crystal display that suppresses defects caused by variation in process and improves display performance. The present invention is a liquid crystal display including: a first electrode; an insulating film provided on the first electrode; and a second electrode provided on the insulating film, the second electrode having a plurality of slits formed within a pixel, the first electrode facing the plurality of slits, the plurality of slits being parallel with each other, the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion, a plurality of the first straight portions having the second ends aligned along the same straight line, on an assumption of a first slit being an endmost slit among the plurality of slits in the pixel, a slit next to the first slit bending in a manner that the first straight portion and the second straight portion of the slit come closer to the first slit, a slit more distant from the first slit having a shorter first straight portion.

### TECHNICAL FIELD

The present invention relates to a liquid crystal display. More specifically, the present invention relates to a liquid crystal display suitable for a horizontal electric field liquid crystal display.

### BACKGROUND ART

Active matrix liquid crystal displays utilizing active elements such as thin film transistors (TFTs) are widely spread as display devices because they are thin and light and provide high-definition images that compare with images provided by CRT displays. Roughly two display formats mentioned below are known as display formats of such liquid crystal displays.

One is a vertical electric field mode. In this mode, an electric field in a direction substantially perpendicular to the substrate surface drives a liquid crystal layer, and modulates light incident on the liquid crystal layer, thereby performing display. Exemplary vertical electric field liquid crystal modes include TN (Twisted Nematic) mode and MVA (Multi-domain Vertical Alignment) mode.

The other is a transverse electric field mode. In this mode, an electric field in a direction substantially parallel to the substrate surface drives a liquid crystal layer. Exemplary transverse electric field liquid crystal modes include IPS (In-plane Switching) mode and FFS (Fringe Field Switching) mode.

Specific examples of the IPS mode include a liquid crystal display including first and second substrates, plural gate wirings and plural data wirings, a thin film transistor, a common wiring, a common electrode, a pixel electrode, and a liquid crystal layer (see Patent Literature 1). In the liquid crystal display, the plural gate wirings and the plural data wirings on the first substrate are orthogonal to each other and define a unit pixel that is divided into first, second, and third regions. The thin film transistors are formed at the intersections of the gate wirings and the data wirings. The common wiring is parallel with the gate wirings and branched into the common electrode that is bent in the first, second, and third regions respectively at first, second, and third angles. The pixel electrode is connected to a drain electrode of the thin film transistor and formed parallel with the common electrode. The liquid crystal layer is arranged between the first substrate and the second substrate that faces the first substrate.

Specific examples of the FFS mode include a transverse electric field-type liquid crystal display panel that has slit openings having a doglegged shape formed by connecting slit openings extending in different directions (see Patent Literature 2). Another example is a liquid crystal display including an electrode that has a straight portion, a first slit, and a second slit. From one side of the straight portion extending in a first direction, the first slit extends in a second direction that is different from the first direction. From the other side of the straight portion, the second slit extends in a third direction that is different from the first and second directions (see Patent Literature 3).

### CITATION LIST

### Patent Literature

Patent Literature 1: JP-A 2007-11259
Patent Literature 2: JP-A 2010-102284
Patent Literature 3: JP-A 2010-256547

### SUMMARY OF INVENTION

### Technical Problem

A transverse electric field-type liquid crystal display includes an electrode (e.g., pixel electrode) in which plural slits are formed in parallel with each other, and a transverse electric field is generated using the electrode. The panel transmittance thereof varies in accordance with the width (S) of the slit, the width (L) of (a linear portion of) the electrode between the slits, and the sum of them (S+L). Generally, a smaller sum of L and S indicates a higher panel transmittance. Due to limitations in the production process, L and S each cannot be smaller than a predetermined value, so that the actual panel transmittance is limited. The reason for this is that there is a limitation to the minimum width of a pattern formed on a photomask that is used in the photolithography step for forming slits and to the minimum width of a pattern that can be actually formed by a device used in the photolithography step.

The following will describe problems related to a conventional FFS mode with reference to a FFS-mode liquid crystal display according to Comparative Embodiment 1 studied by the present inventors. FIG. 10 is a schematic plan view of an active matrix substrate in a FFS-mode liquid crystal display according to Comparative Embodiment 1. Embodiments similar to Comparative Embodiments are shown in FIG. 9 of Patent Literature 2 and FIG. 6 of Patent Literature 3.

A liquid crystal display according to Comparative Embodiment 1 includes an active matrix substrate (array substrate) 510, a counter substrate (not illustrated) facing the array substrate, and a horizontal alignment-type liquid crystal layer (not illustrated) provided between the substrates. The array substrate 510 includes, as illustrated in FIG. 10, a data bus line 513, a gate bus line 551, a TFT 553, a common electrode 515, an insulating film (not illustrated) formed on the common electrode 515, and a pixel electrode 517 formed on the insulating film. The initial alignment direction, namely, the alignment direction under application of no voltage, of liquid crystal molecules is set to the vertical direction of FIG. 10.

Each pixel electrode 517 has plural slits 530 formed in parallel with each other. The common electrode 515 faces the slits 530. Control of the voltage to be applied between the pixel electrode 517 and the common electrode 515 allows control of alignment of liquid crystal molecules, more specifically, rotation of liquid crystal molecules. The pixel electrode 517 includes plural linear portions 517 formed in parallel with each other and connecting portions 519 and 520 connecting the linear portions to each other.

Each slit 530 has a symmetrical shape to the top and bottom, and includes the straight portions (main portions) 531 and 532, a portion (V portion) 533 that connects the main portions 531 and 532 to each other and is formed of two straight portions combined in a V shape, and linear portions (auxiliary portions) 534 and 535 respectively provided between the main portion 531 and the connecting portion 519 and between the main portion 532 and the connecting portion 520. As mentioned above, each slit 530 bends between the auxiliary portion 534 and the main portion 531, between the main portion 531 and the V portion 533, between the main portion 532 and the V portion 533, and between the main portion 532 and the auxiliary portion 535. In addition, the V portion 533 has one bent portion. Accordingly, each slit 530 has five bent portions. The V portion 533 and the auxiliary portions 534 and 535 each have a larger angle of tilt relative to the vertical direction than the main portions 531 and 532.

The V portion 533 and the auxiliary portions 534 and 555 are subsidiary portions. The alignment of most liquid crystal molecules in the liquid crystal layer is controlled in regions including the main portions 531 and 532. The rotation direction of liquid crystal molecules in the region including the main portion 531 is opposite from that in the region including the main portion 532, and therefore, the alignments of liquid crystal molecules collide with each other between the regions. For facilitating the alignment of liquid crystal molecules between the regions, the V portion 533 which has a comparatively large angle of tilt relative to the vertical direction is provided between the regions. In the vicinity of the connecting portion 519, the alignment of liquid crystal molecules may be disturbed by the electric field generated from the connecting portion 519. For suppressing alignment disorder of liquid crystal molecules in the vicinity of the connecting portion 519, the auxiliary portion 534 which has a comparatively large angle of tilt relative to the vertical direction is provided between the connecting portion 519 and the main portion 531. The auxiliary portion 535 is provided for the similar reason. As a result, even when a local pressure is applied to the screen of the liquid crystal display from outside (e.g., when the screen is pressed by fingers) to cause locally disordered alignment of liquid crystal molecules, namely, locally disturbed display, such a defect is quickly recovered.

Comparative Embodiment 1, however, has problems mentioned below.

The slits 530 are provided in parallel with each other and have the same planar shape. In this case, the V portion 533 and the auxiliary portions 534 and 535 each have a width S narrower than the width S of the main portions 531 and 532. In addition, the width L of the linear portion 518 of the pixel electrode 517 is narrower in portions forming the V portion 533 and the auxiliary portions 534 and 535 than in portions forming the main portions 531 and 532. If the widths L and S in regions including the main portions 531 and 532 are minimized to the allowable limits in terms of the process for the purpose of increasing the panel transmittance, the widths L and S in the region including the V portion and in the regions including the auxiliary portion 534 and 535 may be below the allowable limits. In such a case, various defects caused by variation in process may occur. Specifically, luminance may vary from one panel to another, or the display may be non-uniform even within one panel. Such defects are presumably caused by disordered alignment of the mask, variation in width of the pattern, and the like.

From the standpoint of suppressing such defects, if the widths L and S in the region including the V portion 533 and in the regions including the auxiliary portions 534 and 535 are set within the allowable limits, the widths L and S in the regions including the main portions 531 and 532 are large, causing deterioration in display performance, for example, reduction in the panel transmittance.

As described above, suppression of defects caused by variation in process and improvement in display performance are hardly achieved at the same time in a conventional FFS mode.

The present invention has been devised in consideration of the state of the art, and aims to provide a liquid crystal display that enables suppression of defects caused by variation in process and improvement in display performance.

### Solution to Problem

The present inventors have intensively studied about a liquid crystal display that enables suppression of defects caused by variation in process and improvement in display performance to find out the following fact. In a liquid crystal display, a plurality of slits are provided in parallel with each other, the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion. The plurality of the first straight portions having the second ends aligned along the same straight line. On an assumption of a first slit being an endmost slit among the plurality of slits in the pixel (here, a slit next to the first slit bends in a manner that the first straight portion and the second straight portion of the slit come closer to the first slit), a slit more distant from the first slit has a shorter first straight portion. This configuration reduces the difference between the widths L and S in the region including the first straight portion and the widths L and S in the region including the second straight portion. In this case, even when the width L and S in the region including the second straight portion are close to the allowable limits, the widths L and S in the region including the first straight portion are prevented from falling below the allowable limits. As a result, variation in the slit pattern caused by variation in process is suppressed, and the transmittance can be increased. In this manner, the present inventors succeeded in solving the above problems to complete the present invention.

One aspect of the present invention is a liquid crystal display (hereinafter, also referred to as a liquid crystal display according to the present invention) including: a first substrate; a second substrate facing the first substrate; and a liquid crystal layer that is positioned between the first substrate and the second substrate and contains liquid crystal molecules, the first substrate including a first electrode, an insulating film provided on the first electrode, and a second electrode provided on the insulating film, the second electrode having a plurality of slits formed within a pixel, the first electrode facing the plurality of slits, the plurality of slits being parallel with each other, the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion, a plurality of the first straight portions having the second ends aligned along the same straight line, on an assumption of a first slit being an endmost slit among the plurality of slits in the pixel, a slit next to the first slit bending in a manner that the first straight portion and the second straight portion of the slit come closer to the first slit, a slit more distant from the first slit having a shorter first straight portion.

The configuration of the liquid crystal display of the present invention is not especially limited by other components as long as it essentially includes such components. The straight line is not a physical part but is a virtual line.

The following will discuss preferable embodiments of the liquid crystal display according to the present invention. The following embodiments may be employed in combination.

When an alignment direction of the liquid crystal molecules under application of no voltage is set as an initial alignment direction, the first direction and the second direction are preferably each different from the initial alignment direction. This configuration allows more effective control of the alignment of liquid crystal molecules.

Preferably, the first direction and the initial alignment direction form an angle larger than an angle formed by the second direction and the initial alignment direction, and the first straight portion is shorter than the second straight portion. This configuration enables the first straight portion and the second straight portion to function more effectively as a supplemenraty portion (auxiliary portion) and a main portion, respectively.

Preferably, the first direction and the initial alignment direction form an angle of 20° to 40°, the second direction and the initial alignment direction form an angle of 3° to 10°, the straight line is a first straight line, the bent portions of the plurality of slits are aligned along a second straight line, and the first straight line and the second straight line form an angle of 5° to 15°. This configuration effectively enables recovery from disordered alignment caused by pressing and increase in the transmittance at the same time. The second straight line is not a physical part but is a virtual line.

The plurality of slits each may have a third straight portion being connected to the second end of the first straight portion and extending in a third direction, and the first straight portion and the third straight portion may form a V shape. This embodiment is suitable for a case where a V portion is provided at the center of a pixel.

Preferably, when the alignment direction of the liquid crystal molecules under application of no voltage is set as an initial alignment direction, the third direction and the initial alignment direction form an angle of 20° to 40°, the plurality of slits each further have a fourth straight portion and a second bent portion, the fourth straight portion being connected to an end of the third straight portion on the side not connected to the first straight portion and extending in a fourth direction, the second bent portion bent in a connecting region of the third straight portion and the fourth straight portion, the straight line is a first straight line, the second bent portions of the plurality of slits are aligned along a third straight line, the first straight line and the third straight line form an angle of 5° to 15°, and the fourth direction and the initial alignment direction form an angle of 3° to 10°. This configuration effectively enables recovery from disordered alignment caused by pressing and increase in the transmittance at the same time. The third straight line is not a physical part but is a virtual line.

The second electrode may include at least three linear portions adjacent to the plurality of slits and a connecting portion connecting the at least three linear portions to each other, and the first straight portion may be adjacent to the connecting portion. This embodiment is suitable for a case where an auxiliary portion is provided next to a connecting portion of an electrode.

### Advantageous Effects of Invention

The present invention realizes a liquid crystal display that can achieve suppression of defects caused by variation in process and improvement in display performance at the same time.

### BRIEF DESCRIPTION OF DRAWINGS

FIG. 1 is a schematic plan view of an active matrix substrate of a FFS-mode liquid crystal display according to Embodiment 1.

FIG. 2 is a schematic plan view of a common electrode provided on an active matrix substrate according to Embodiment 1.

FIG. 3 is a schematic cross-sectional view of an active matrix substrate taken along an A-A′ line in FIG. 1.

FIG. 4 is an enlarged schematic plan view of a vicinity of a V portion of a pixel electrode according to Embodiment 1.

FIG. 5 is a schematic plan view of an active matrix substrate of a FFS-mode liquid crystal display according to Embodiment 2.

FIG. 6 is an enlarged schematic plan view of a vicinity of an auxiliary portion of a pixel electrode according to Embodiment 2.

FIG. 7 is a schematic plan view of an active matrix substrate of a FFS-mode liquid crystal display according to Embodiment 3.

FIG. 8 is a schematic plan view of an active matrix substrate of a FFS-mode liquid crystal display according to a modified example of Embodiment 3.

FIG. 9 is a schematic plan view of a common electrode provided on an active matrix substrate of a modified example of Embodiment 3.

FIG. 10 is a schematic plan view of an active matrix substrate of a FFS-mode liquid crystal display according to Comparative Embodiment 1.

### DESCRIPTION OF EMBODIMENTS

The present invention will be mentioned in more detail referring to the drawings in the following embodiments, but is not limited to these embodiments.

The term “pixel” as used herein refers to a region surrounded by adjacent two gate bus lines and adjacent two data bus lines.

Unless otherwise specified, the width is taken in the direction orthogonal to the longitudinal direction.

The following embodiments are specifically applicable to display devices such as TVs, PCs, mobile phones, car navigation systems, and information displays.

### Embodiment 1

A multi-domain (2-domain) FFS-mode liquid crystal display is discussed in Embodiment 1.

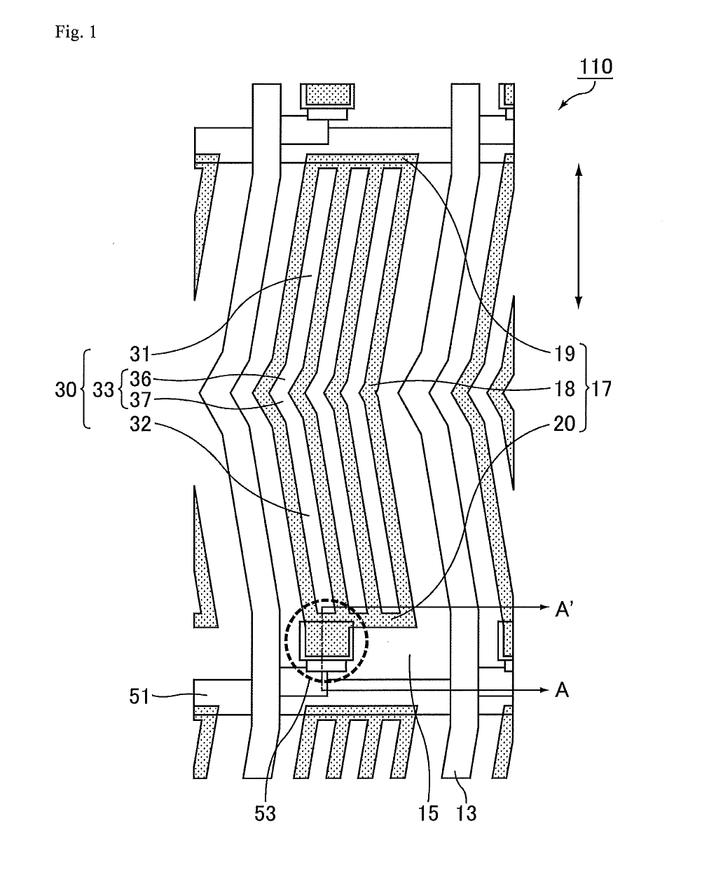

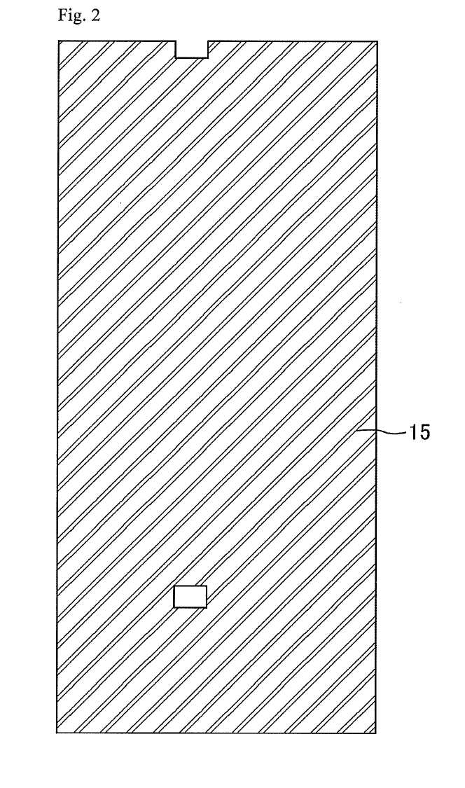

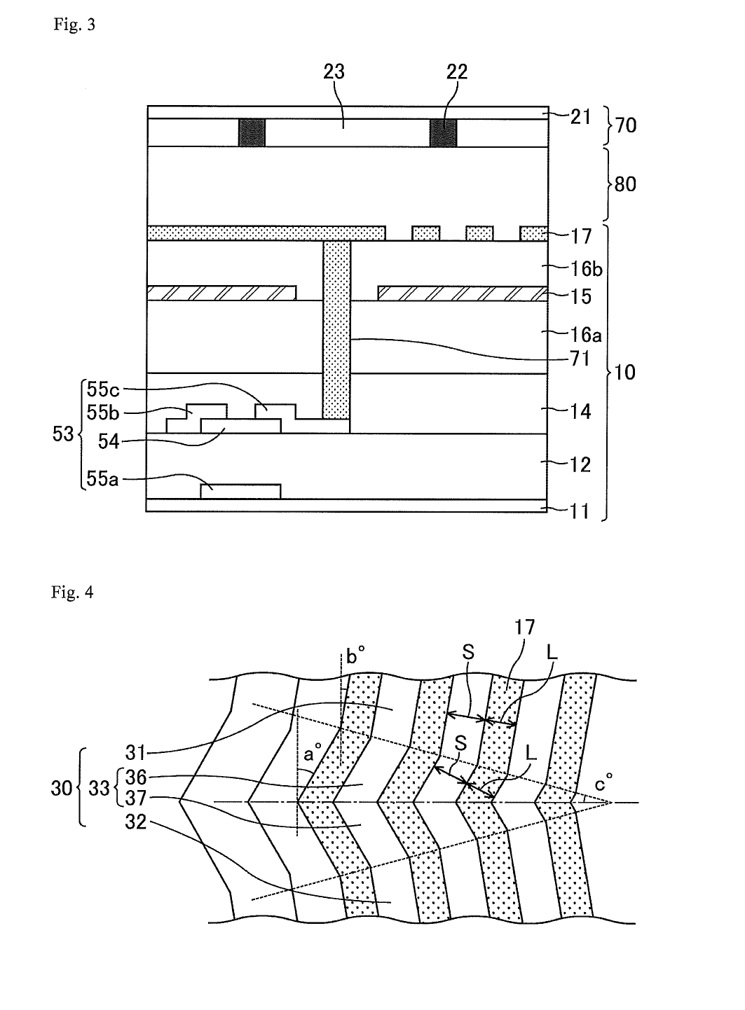

FIG. 1 is a schematic plan view of an active matrix substrate of a FFS-mode liquid crystal display according to Embodiment 1. A liquid crystal display 110 according to Embodiment 1 includes an active matrix substrate (array substrate) 10, a counter substrate 70 facing the substrate 10, and a horizontal alignment-type liquid crystal layer 80 provided between the substrates. The array substrate 10 includes, as illustrated in FIGS. 1 and 3, an insulating substrate 11, a data bus line 13, a gate bus line 51, a gate insulator 12, a TFT 53, a first insulating film 14, a second insulating film 16a, a common electrode 15, a third insulating film 16b formed on the common electrode 15, and a pixel electrode 17 formed on the third insulating film 16b. The array substrate 10 has a horizontal alignment film (not illustrated) on a surface on the liquid crystal layer 80 side. The common electrode 15 is, as illustrated in FIG. 2, formed so as to substantially cover the display region. The pixel electrode 17 has plural slits (longitudinal openings) 30 formed in parallel with each other, and the common electrode 15 faces the slits 30. Control of a voltage applied between the pixel electrode 17 and the common electrode 15 enables control of the alignment of liquid crystal molecules, more specifically, rotation of liquid crystal molecules. The initial alignment direction, namely, the alignment direction under application of no voltage, of liquid crystal molecules is set to the vertical direction of FIG. 1 (direction indicated by an arrow in FIG. 1). The counter substrate 70 includes an insulating substrate 21, a color filter 23, and a black matrix 22. The counter substrate 70 has a horizontal alignment layer (not illustrated) on a surface on the liquid crystal layer 80 side. The color filter 23 and the black matrix 22 may be provided on the active matrix substrate 10 side, not on the counter substrate 70 side.

The configuration of the pixel electrode 17 in Embodiment 1 is more specifically described.

The pixel electrode 17 includes at least three linear portions 18 formed in parallel with each other, and connecting portions 19 and 20 each connecting the linear portions 18 to each other.

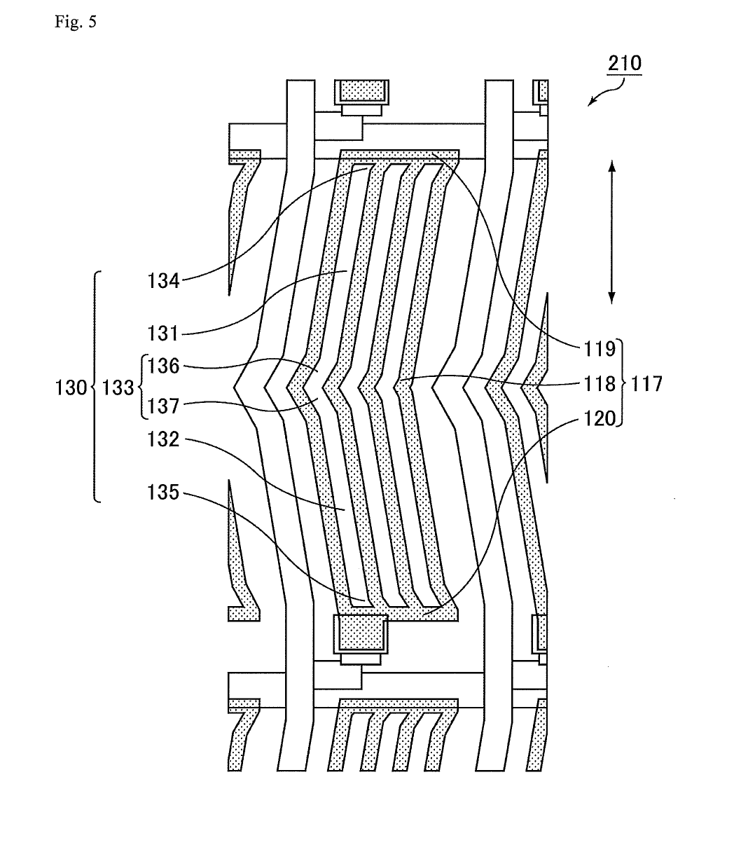

Each slit 30 has a symmetrical shape to the top and bottom, and includes straight portions (main portions) 31 and 32, and portion (V portion) 33 that connects the main portions 31 and 32 to each other and is formed of two straight portions 36 and 37 combined in a V shape. The main portions 31 and 32 each correspond to the second straight portion, and the straight portions 36 and 37 each correspond to the first or third straight portion. As above, each slit 30 bends between the main portion 31 and the V portion 33, and between the main portion 32 and the V portion 33. In addition, the V portion has one bent portion. Accordingly, each slit 30 has three bent portions. As illustrated in FIG. 4, the angle (a°) of tilt of the V portion 33 relative to the vertical direction (the initial alignment direction of liquid crystal molecules) is set to be larger than the angle (b°) of tilt of each of the main portions 31 and 32 relative to the vertical direction (the initial alignment direction of liquid crystal molecules). The V portion 33 (straight portions 36 and 37) is a subsidiary portion. The alignment of most liquid crystal molecules in the liquid crystal layer 80 is controlled in regions including the main portions 31 and 32. The V portion 33 allows more effective control of the alignment of liquid crystal molecules. As a result, even when a local pressure is applied to the screen of the liquid crystal display 110 from outside (e.g., when the screen is pressed by fingers) to cause locally disordered alignment of liquid crystal molecules, namely, locally disturbed display, such a defect is quickly recovered. In the data bus line 13, a portion facing the slit 30 is formed so as to follow the slit 30.

When the leftmost slit in FIG. 1, among the slits 30, is a first slit, a slit more distant from the first slit has shorter straight portions 36 and 37 that form the V portion 33. The first slit is an endmost slit in the pixel, and the slit next to the first slit bends in a manner that the main portion 31 and the straight portion 36 come close to the first slit. The slit next to the first slit also bends in a manner that the main portion 32 and the straight portion 37 come close to the first slit. For example, the lengths of the pixel electrode parts adjacent to the straight portion 36 or 37 are 3 μm, 4 μm, 5 μm and 6 μm in sequence from the observer's right in FIG. 1. Specifically, as illustrated in FIG. 4, in the central portion of the pixel electrode 17, the V portions 33 are formed in a manner that the size is gradually decreased from left to right. The bent portions between the main portions 31 and the V portions 33 of the slits 30, namely, the first ends of the straight portions 36 are aligned along a second virtual straight line (straight line corresponding to the second or third straight line). The bent portions between the main portions 32 and the V portions 33 of the slits 30, namely, the first ends of the straight portions 37, are aligned along a third virtual straight line (straight line corresponding to the second or third straight line). Top points of the V portions 33 of the slits 30, namely the second ends of the straight portions 36 and 37, are aligned along a first virtual straight line (straight line corresponding to the first straight line). The first virtual straight line and the second virtual straight line form a predetermined angle (c°). Similarly, the first virtual straight line and the third virtual straight line form a predetermined angle (c°). In a slit more distant from the first slit, a bent portion between the main portion 31 and the V portion 33 and a bent portion between the main portion 32 and the V portion 33 are closer to the first virtual straight line.

The pixel electrode 17 having such a configuration can have a smaller difference between the widths L and S in the regions including the main portions 31 and 32 and the widths L and S in the region including the V portion 33 (straight portions 36 and 37). Moreover, the widths L and S in both regions can be substantially the same.

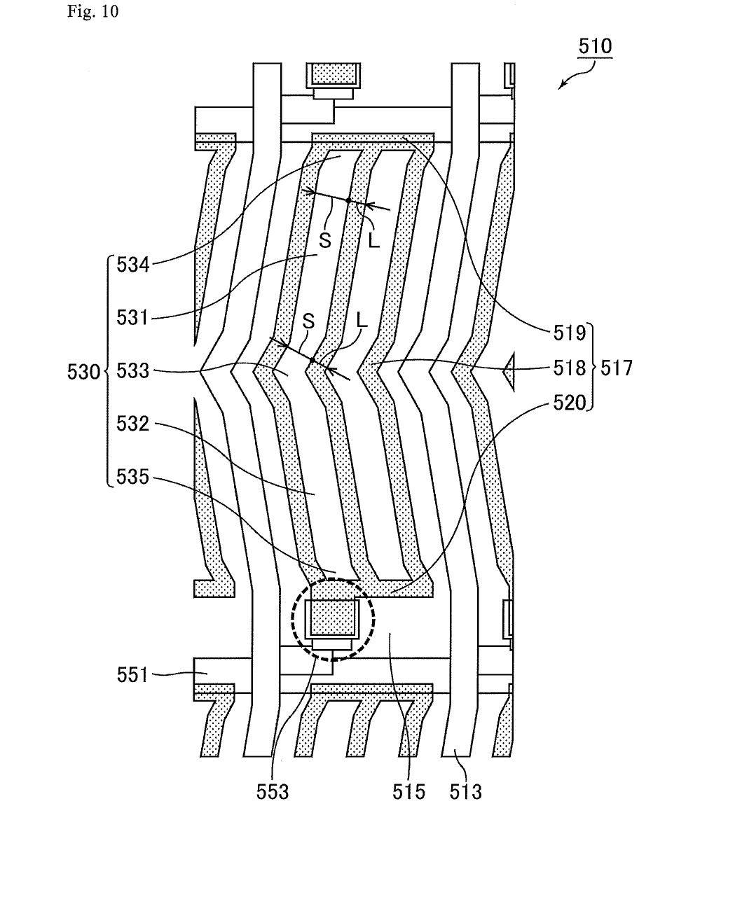

In the conventional FFS-mode liquid crystal display 510 of Comparative Embodiment 1, as illustrated in FIG. 10, all electrodes between slits have substantially the same shape, and the angle c° as illustrated in FIGS. 1 and 4 is not present.

Then, as described above, the V portion 533 and the auxiliary portions 534 and 535 each have a width S narrower than the width S of the main portions 531 and 532. In addition, the width L of the linear portion 518 in the pixel electrode 517 is narrower in parts forming the V portion 533 and the auxiliary portions 534 and 535 than in parts forming the main portions 531 and 532.

Accordingly, in the case where the sum of the widths L and S are to be minimized as far as possible in the liquid crystal display 510 of Comparative Embodiment 1, the sum of the widths L and S in the region including the V portion 533 needs to be designed to satisfy the allowable limit. For example, in the case where the allowable limits of the width L and the width S are, respectively, 2.5 μm and 4.0 μm (the sum of the widths L and S is 6.5 μm), if the width L of the electrode parts forming the main portions 531 and 532 and the width S of the main portions 531 and 532 are respectively set to the minimum values of 2.5 μm and 4.0 μm, the width of the electrode forming the V portion 533 is about 2.2 μm, and the width S of the V portion 533 is about 3.4 μm. These widths are smaller than the allowable limits. As a result, when variation in process, such as disordered alignment of the photomask, occurs, variation in transmittance from one liquid crystal display panel to another, or variation in transmittance within one liquid crystal display panel (display region) (non-uniform display) may occur. The widths L and S therefore need to be set within the allowable limits in the region including the V portion 533 in the liquid crystal display 510 of Comparative Embodiment 1. In such a case, however, the widths L and S in the regions including the main portions 531 and 532 are likely to be large, resulting in reduction in display performance, such as reduction in the panel transmittance.

In the liquid crystal display 110 of Embodiment 1, the difference is smaller between the widths L and S in the regions including the main portions 31 and 32 and the widths L and S in the region including the V portion 33 (straight portions 36 and 37). In this case, even when the widths L and S in the regions including the main portions are close to the allowable limits, the widths L and S in the region including the V portion are prevented from falling below the allowable limits. As a result, change in the slit pattern caused by variation in process is suppressed, enabling improvement in the transmittance. Specifically, when the widths L and S in the regions including the main portions 31 and 32 and the widths L and S in the region including the V portion 33 (straight portions 36 and 37) are reduced to the limits acceptable in terms of the process and set to substantially the same width, the liquid crystal display 110 of Embodiment 1 has a transmittance larger than that of the liquid crystal display 510 of Comparative Embodiment 1 illustrated in FIG. 10 by 4%.

The angle a° and the angle b° are not particularly limited, and may be set in a manner that an appropriate viewing angle as a multi-domain liquid crystal display is secured, that disclination is suppressed, and that pressure resistance is achieved. Specifically, the angle a° is preferably set to 20° to 40°, and the angle b° is preferably set to 3° to 10°.

The angle c° is also not particularly limited, and is preferably set in a manner that the sum of the widths L and S is minimized in the entire slit within the manufacturable limits. Specifically, the angle c° is preferably set to 5° to 15°.

The configuration of the pixel electrode 17 in Embodiment 1 has been described. In the following, descriptions are given on other configurations, and materials and production methods of the components.

The TFT 53 is a switching element including a semiconductor layer 54, a gate electrode 55a, a source electrode 55b, and a drain electrode 55c. The gate electrode 55a of the TFT 53 is formed of a portion of the gate bus line 51. The source electrode 55b and the drain electrode 55c of the TFT 53 are each connected to the semiconductor layer 54. The drain electrode 55c of the TFT 53 is connected to the pixel electrode 17 via a contact hole 71. The gate electrode 55a and the semiconductor layer 54 overlap one another via the gate insulator 12. The source electrode 55b is connected to the drain electrode 55c via the semiconductor layer 54. A scanning signal sent to the gate electrode 55a through the gate bus line 51 controls the current flowing in the semiconductor layer 54, thereby controlling transmission of a data signal sent through the data bus line 13 to the source electrode 55b, the semiconductor layer 54, the drain electrode 55c, and the pixel electrode 17 in the stated order.

A constant common signal is supplied to the common electrode 15. As illustrated in FIG. 2, the common electrode 15 formed is spread regardless of the borders of pixels. The common electrode 15 has openings in a region where the drain electrode 55c and the pixel electrode 17 are connected to each other.

Insulating substrates 11 and 21 are favorably formed of transparent materials such as glass and plastics. The gate insulator 12, the first insulating film 14, the second insulating film 16a, and the third insulating film 16b are favorably formed of transparent materials such as silicon nitride, silicon oxide, and photosensitive acrylic resin. For formation of the first insulating film 14, the second insulating film 16a, and the third insulating film 16b, for example, a silicon nitride film is formed by plasma enhanced chemical vapor deposition (PECVD), and then a photosensitive acrylic resin film is formed on the silicon nitride film by die-coating. A hole provided in the insulating films 14, 16a, and 16b for formation of a contact portion is formed by dry etching (channel etching).

For formation of the gate bus line 51, the data bus line 13, or various wirings and electrodes included in the TFT 53, a metal (e.g., titanium, chromium, aluminum, molybudenum) or an alloy thereof is deposited by sputtering or the like to form a mono- or multi-layer film, and then patterning is performed by photolithography or the like. For production efficiency, these wirings and electrodes formed in the same layer are preferably formed of the same material.

The semiconductor layer 54 of the TFT 53 includes, for example, a high-resistance semiconductor layer formed of amorphous silicon, poly silicon, or the like and a low-resistance semiconductor layer formed of n+amorphous silicon that is prepared by doping amorphous silicon with impurities such as phosphor. An oxide semiconductor layer such as a zinc oxide layer may be used as a semiconductor layer 54. The shape of the semiconductor layer 54 may be determined by patterning by photolithography or the like performed after film formation by PECVD or the like.

For formation of the pixel electrode 17 and the common electrode 15, for example, a transparent conductive material (e.g., indium tin oxide (ITO), indium zinc oxide (IZO), zinc oxide (ZnO), tin oxide (SnO)) or an alloy thereof may be deposited by sputtering or the like to form a mono- or multi-layer film, and then patterning is performed by photolithography. The slits 30 formed in the pixel electrode 17 and openings formed in the common electrode 15 may be formed simultaneously with patterning.

For formation of the color filter 23, photosensitive resins (color resists) transmitting light corresponding to the respective filter colors are favorably used. The material of the black matrix 22 is not particularly limited as long as it blocks light. Favorably used are resin materials containing black pigments or light-blocking metallic materials.

Thus formed active matrix substrate 10 and the counter substrate 70 are bonded to each other using a sealing material after plural cylindrical spacers formed of an insulating material are provided on one of the substrates. The liquid crystal layer 80 is formed between the active matrix substrate 10 and the counter substrate 70. In the case of using dropwise addition for formation of the liquid crystal layer 80, liquid crystal materials are dripped before the substrates are bonded to each other. In the case of using a vacuum injection method, liquid crystal materials are injected after the substrates are bonded to each other. The liquid crystal layer 80 contains liquid crystal molecules (preferably, nematic liquid crystal molecules) having a positive anisotropy of dielectric constant. Then, a polarizer, a retardation film, or the like are attached to the surface of each substrate not facing the liquid crystal layer 80. Thus, a liquid crystal display panel is produced. Moreover, a liquid crystal display panel may be equipped with a gate driver, a source driver, and a display control circuit and the like, and combined with a back light unit or the like, thereby providing a liquid crystal display suitable for an intended application.

The configuration of the liquid crystal display panel of Embodiment 1 is determined and measured using, for example, an optical microscope (OLYMPUS CORPORATION, a semiconductor & flat panel display inspection microscope MX61L) and a scanning transmission electron microscope with an energy dispersive X-ray spectroscope (STEM-EDX, Hitachi High-Technologies Corporation, HD-2700).

### Embodiment 2

Embodiment 2 discusses a multi-domain (2-domain) type FFS mode liquid crystal display.

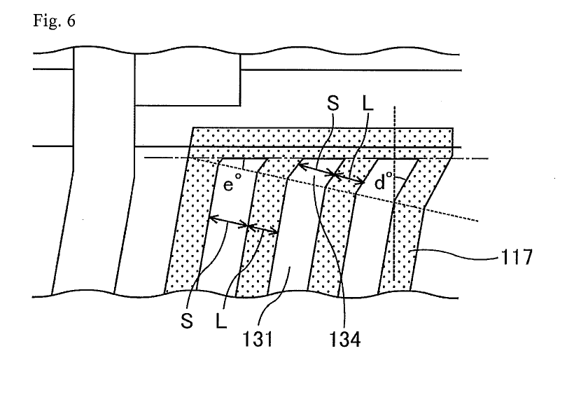

FIG. 5 is a schematic plan view of an active matrix substrate of a FFS mode liquid crystal display according to Embodiment 2. In Embodiment 1, as illustrated in FIG. 1, the number of bent portions formed is three in total including a bent portion between the main portion 31 and the V portion 33, a bent portion between the main portion 32 and the V portion 33, and the V portion. In Embodiment 2, linear portions (auxiliary portions) 134 and 135 are formed in addition to the main portions 131 and 132 and the V portion 133. Accordingly, the number of bent portions formed is five in total further including a bent portion between the main portion 131 and the auxiliary portion 134, and a bent portion between the main portion 132 and the auxiliary portion 135. Other configurations are as same as those of Embodiment 1, and therefore, descriptions thereof are omitted here. In the following, a description is given on the configuration of a pixel electrode 117 in a liquid crystal display 210 of Embodiment 2.

The pixel electrode 117 has plural slits 130 formed in parallel with each other, and also includes at least three linear portions 118 formed in parallel with each other and connecting portions 119 and 120 connecting the linear portions 118 to each other.

Each slit 130 has a symmetrical shape to the top and bottom and includes straight portions (main portions) 131 and 132 and portion (V portion) 133 that connects the main portions 131 and 132 to each other and is formed of two straight portions 136 and 137 combined in a V shape. The main portions 131 and 132 each correspond to the second straight portions and the straight portions 136 and 137 each correspond to the first or third straight portion. From the similar standpoint as in Embodiment 1, the angle of tilt (a°) of the V portion 133 relative to the vertical direction is set to be larger than the angle (b°) of tilt of each of the main portions 131 and 132 relative to the vertical direction.

The slits 130 include linear portions (auxiliary portions) 134 and 135 provided between the main portions 131 and 132 and the connecting portions 119 and 120, respectively. The auxiliary portions 134 and 135 each correspond to the first straight portion. As illustrated in FIG. 6, the angle (d°) of tilt of the auxiliary portion 134 or 135 relative to the initial alignment direction (indicated by an arrow in FIG. 5) of liquid crystal molecules is set to be larger than the angle (b°) of tilt of the main portion 131 or 132 relative to the vertical direction. The auxiliary portions 134 and 135 are subsidiary portions as the V portion 133 (straight portions 136 and 137) is. The alignment of most liquid crystal molecules is controlled in the regions including the main portions 131 and 132. In the vicinity of the connecting portion 119, the alignment of liquid crystal molecules may be disturbed by the electric field generated from the connecting portion 119. For suppressing the alignment disorder of liquid crystal molecules in the vicinity of the connecting portion 119, the auxiliary portion 134 which has a relatively large angle of tilt relative to the vertical direction is provided between the connecting portion 119 and the main portion 131. The auxiliary portion 135 is provided for the similar reason.

In Embodiment 1, the description given is based on the assumption that the leftmost slit in FIG. 1 is the first slit, with a focus on the main portions 31 and 32 and the V portion 33 (straight portions 36 and 37). In the present embodiment, the rightmost slit in FIG. 5 corresponds to the first slit with a focus on the auxiliary portions 134 and 135. The first slit is an endmost slit in the pixel, and the slit next to the first slit bends in a manner that the main portion 131 and the auxiliary portion 134 come close to the first slit. The slit next to the first slit bends in a manner that the main portion 132 and the auxiliary portion 135 come close to the first slit. A slit more distant from the first slit has shorter auxiliary portions 134 and 135. For example, the lengths of the pixel electrode parts adjacent to the auxiliary portion 134 or 135 are 5.5 μm, 4 μm, 2.5 μm, and 1 μm in sequence from the observer's right in FIG. 5. Ends of the auxiliary portions 134 and 135 of the slits 130 on one side are aligned along a second virtual straight line (a straight line corresponding to the second straight line). The other ends of the auxiliary portions 134 and 135 are aligned along a first virtual straight line (a straight line corresponding to the first straight line). As illustrated in FIG. 6, the first virtual straight line and the second virtual straight line form a predetermined angle (e°). In a slit more distant from the first slit, a bent portion between the auxiliary portion 134 and the main portion 131 and a bent portion between the auxiliary portion 135 and the main portion 132 are closer to the first virtual straight line.

The pixel electrode 117 having such a configuration has a smaller difference between the widths L and S in the regions including the main portions 131 and 132 and the widths L and S in the regions including the auxiliary portions 134 and 135. Moreover, the widths L and S in both regions can be substantially the same, respectively.

In the conventional FFS-mode liquid crystal display 510 of Comparative Embodiment 1, as illustrated in FIG. 10, all electrodes between slits have substantially the same shape, and the angle e° as illustrated in FIG. 6 is not present.

Then, as described above, the auxiliary portions 534 and 535 have a width S narrower than the width S of the main portions 531 and 532.

Accordingly, In the case where the sum of the width L and the width S are to be minimized as far as possible in the liquid crystal display 510 of Comparative Embodiment 1, the sum of the width L and the width S in the regions including the auxiliary portions 534 and 535 needs to be designed to satisfy the allowable limit. For example, in the case where the allowable limits of the width L and the width S are, respectively, 2.5 μm and 4.0 μm (the sum of the widths L and S is 6.5 μm), if the width L of the electrode part forming the main portions 531 and 532 and the width S of the main portions 531 and 532 are respectively set to the minimum values of 2.5 μm and 4.0 μm, the width of the electrodes forming the auxiliary portions 534 and 535 is about 2.0 μm and the width S of the auxiliary portions 534 and 535 is about 4.1 μm. These widths are smaller than the allowable limits. As a result, when variation in process, such as disordered alignment of the photomask, occurs, variation in transmittance from one liquid crystal display panel to another, or variation in transmittance within one liquid crystal display panel (display region) (non-uniform display) may occur. The widths L and S therefore need to be set within the allowable limits in the regions including the auxiliary portions 534 and 535 in the liquid crystal display 510 of Comparative Embodiment 1. In such a case, however, the widths L and S in the regions including the main portions 531 and 532 are likely to be large, resulting in reduction in display performance, such as reduction in panel transmittance.

In the liquid crystal display 210 of Embodiment 2, the difference is smaller between the widths L and S in the regions including the main portions 131 and 132 and the widths L and S in the regions including the auxiliary portions 134 and 135. In this case, even when the widths L and S in the regions including the main portions are close to the allowable limits, the widths L and S in the regions including the auxiliary portions are prevented from falling below the allowable limits. As a result, change in the slit pattern caused by variation in process is suppressed, enabling improvement in transmittance. Specifically, when the widths L and S in the regions including the main portions 131 and 132 and the widths L and S in the regions including the auxiliary portions 134 and 135 are reduced to the limits allowed in terms of the process and set to substantially the same width, respectively, the liquid crystal display 210 of Embodiment 2 has a transmittance larger than that of the liquid crystal display 510 of Comparative Embodiment 1 illustrated in FIG. 10 by 8%.

The angle d° is not particularly limited, and may be set in a manner that an appropriate viewing angle as a multi-domain liquid crystal display is secured, that disclination is suppressed, and that pressure resistance is achieved. Specifically, the angle d° is preferably set to 20° to 40°.

The angle e° is also not particularly limited, and is preferably set in a manner that the sum of the widths L and S is minimized in the entire slit within the manufacturable limits. Specifically, the angle e° is preferably set to 5° to 15°.

### Embodiment 3

Embodiment 3 discusses a mono-domain FFS mode liquid crystal display.

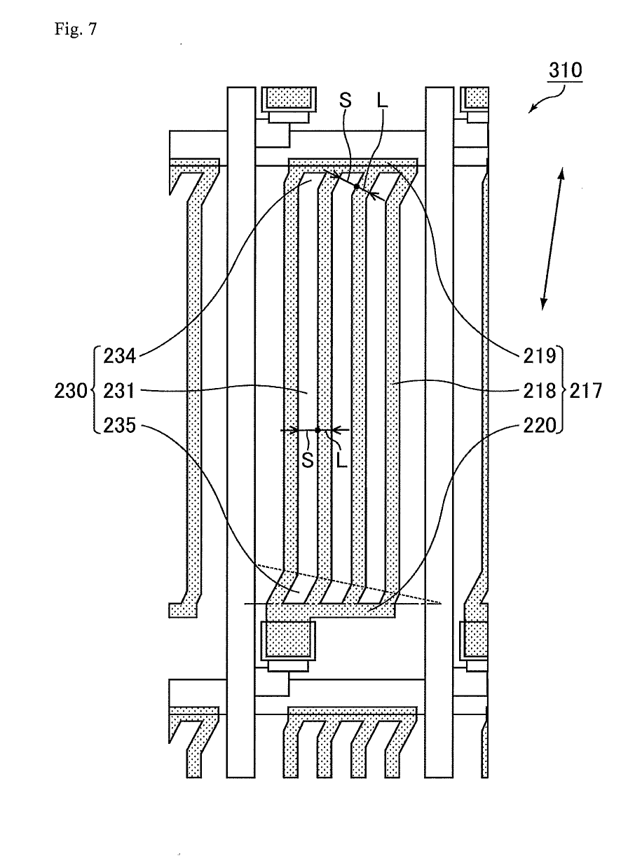

FIG. 7 is a schematic plan view of an active matrix substrate of a FFS-mode liquid crystal display according to Embodiment 3. In Embodiments 1 and 2, the V portions 33 and 133 are formed as illustrated in FIGS. 1 and 5, respectively. In Embodiment 3, a V portion is not formed. In Embodiment 3, a main portion 231 and linear portions (auxiliary portions) 234 and 235 are formed, and two bent portions in total are formed between the main portion 231 and the auxiliary portion 234 and between the main portion 231 and the auxiliary portion 235. Other configurations are as same as those of Embodiment 1, and therefore, descriptions thereof are omitted here. In the following, a description is given on the configuration of a pixel electrode 217 of a liquid crystal display 310 of Embodiment 3.

The pixel electrode 217 has plural slits 230 formed in parallel with each other, and also includes at least three linear portions 218 formed in parallel with each other and connecting portions 219 and 220 connecting the linear portions 218 to each other. In the present embodiment, the initial alignment direction of liquid crystal molecules is set to a direction slightly off the vertical direction in FIG. 7 (direction indicated by an arrow in FIG. 7).

Each slit 230 has a point symmetrical shape and includes linear portions (auxiliary portions) 234 and 235 respectively provided between the main portion 231 and the connecting portion 219 or 220. The main portion 231 corresponds to the second straight portion and the auxiliary portions 234 and 235 each correspond to the first straight portion. From the similar standpoint as in Embodiment 1, the angle formed by the auxiliary portion 234 or 235 and the initial alignment direction of liquid crystal molecules is set to be larger than the angle formed by the main portion 231 and the initial alignment direction of liquid crystal molecules. Moreover, the angle formed by the auxiliary portion 234 and the initial alignment direction of liquid crystal molecules is substantially the same as the angle formed by the auxiliary portion 235 and the initial alignment direction of liquid crystal molecules. In other words, the auxiliary portion 234 extends in a direction opposite to the extending direction of the auxiliary portion 235. The auxiliary portions 234 and 235 are subsidiary portions. The alignment of most liquid crystal molecules in the liquid crystal layer 80 is controlled in the region including the main portion 231. In the vicinity of the connecting portion 219, the alignment of liquid crystal molecules may be disturbed by the electric field generated from the connecting portion 219. For suppressing the alignment disorder of liquid crystal molecules in the vicinity of the connecting portion 219, the auxiliary portion 234 which has a relatively large angle of tilt relative to the vertical direction is provided between the connecting portion 219 and the main portion 231. The auxiliary portion 235 is provided for the similar reason.

In the present embodiment, the rightmost slit in FIG. 7 corresponds to the first slit with a focus on the auxiliary portions 234. The first slit is an endmost slit in the pixel, and the slit next to the first slit bends in a manner that the main portion 231 and the auxiliary portion 234 come close to the first slit. A slit more distant from the first slit has a shorter auxiliary portion 234. Ends of the auxiliary portions 234 of the slits 230 on one side are aligned along a second virtual straight line (a straight line corresponding to the second straight line). The other ends of the auxiliary portions 234 are aligned along a first virtual straight line (a straight line corresponding to the first straight line). The first virtual straight line and the second virtual straight line form a predetermined angle. In a slit more distant from the first slit, a bent portion between the auxiliary portion 234 and the main portion 231 are closer to the first virtual straight line. When the auxiliary portions 235 are focused, a leftmost slit in FIG. 7 corresponds to the first slit. Ends of the auxiliary portions 235 of the slits 230 on one side are aligned along a second virtual straight line (a straight line corresponding to the second straight line). The other ends of the auxiliary portions 235 are aligned along a first virtual straight line (a straight line corresponding to the first straight line). The first virtual straight line and the second virtual straight line form a predetermined angle. In a slit more distant from the first slit, a bent portion between the auxiliary portion 235 and the main portion 231 are closer to the first virtual straight line.

The pixel electrode 217 having such a configuration has a smaller difference between the widths L and S in the region including the main portion 231 and the widths L and S in the regions including the auxiliary portions 234 and 235. Moreover, the widths L and S in both regions can be substantially the same, respectively.

In the conventional FFS-mode liquid crystal display 510 of Comparative Embodiment 1, as illustrated in FIG. 10, all electrodes between slits have substantially the same shape, and the angle formed by the first virtual straight line and the second virtual straight line is not present.

Then, as described above, the auxiliary portions 534 and 535 have a width S narrower than the width S of the main portions 531 and 532.

Accordingly, In the case where the sum of the width L and the width S are to be minimized as far as possible in the liquid crystal display 510 of Comparative Embodiment 1, the sum of the width L and the width S in the region including the auxiliary portions 534 and 535 needs to be designed to satisfy the allowable limit. For example, in the case where the allowable limits of the width L and the width S are, respectively, 2.5 μm and 4.0 μm (the sum of the widths L and S is 6.5 μm), if the width L of the electrode part forming the main portions 531 and 532 and the width S of the main portions 531 and 532 are respectively set to the minimum values of 2.5 μm and 4.0 μm, the width of the electrodes forming the auxiliary portions 534 and 535 is about 2.0 μm and the width S of the auxiliary portions 534 and 535 is about 4.1 μm. These widths are smaller than the allowable limits. As a result, when variation in process, such as disordered alignment of the photomask, occurs, variation in transmittance from one liquid crystal display panel to another, or variation in transmittance within one liquid crystal display panel (display region) (non-uniform display) may occur. The widths L and S therefore need to be set within the allowable limits in the regions including the auxiliary portions 534 and 535 in the liquid crystal display 510 of Comparative Embodiment 1. In such a case, however, the widths L and S in the regions including the main portions 531 and 532 are likely to be large, resulting in reduction in display performance, such as reduction in panel transmittance.

In the liquid crystal display 310 of Embodiment 3, the difference is smaller between the widths L and S in the regions including the main portion 231 and the widths L and S in the regions including the auxiliary portions 234 and 235. In this case, even when the widths L and S in the regions including the main portion are close to the allowable limits, the widths L and S in the regions including the auxiliary portions are prevented from falling below the allowable limits. As a result, change in the slit pattern caused by variation in process is suppressed, enabling improvement in transmittance. Specifically, when the widths L and S in the region including the main portion 231 and the widths L and S in the regions including the auxiliary portions 234 and 235 are reduced to the limits allowed in terms of the process and set to substantially the same width, respectively, the liquid crystal display 310 of Embodiment 3 has a transmittance larger than that of the liquid crystal display 510 of Comparative Embodiment 1 illustrated in FIG. 10 by 8%.

The angle formed by the auxiliary portion 234 and the initial alignment direction of liquid crystal molecules and the angle formed by the auxiliary portion 234 and the initial alignment direction of liquid crystal molecules are not particularly limited, and may be set in a manner that an appropriate viewing angle as a multi-domain liquid crystal display is secured, that disclination is suppressed, and that pressure resistance is achieved. Specifically, the angles are preferably set to 20° to 40°.

The angle formed by the main portion 231 and the initial alignment direction of liquid crystal molecules is not particularly limited, and may be set in a manner that an appropriate viewing angle as a multi-domain liquid crystal display is secured, that disclination is suppressed, and that pressure resistance is achieved. Specifically, the angle is preferably set to 3° to 10°.

The angle formed by the first virtual straight line and the second virtual straight line is not particularly limited, and is preferably set in a manner that the sum of the widths L and S is minimized in the entire slit within the manufacturable limits. Specifically, the angle is preferably set to 5° to 15°.

The following will discusses modified examples of Embodiments 1 to 3.

Though the slit extends in the longitudinal direction in Embodiments 1 to 3, the slit may extend in the short-side direction of the pixel.

In Embodiments 1 to 3, a pixel electrode is formed on a common electrode and has a slit therein. A common electrode may be formed on a pixel electrode and have slits therein. A description is given on such an embodiment with reference to a modified example of Embodiment 3.

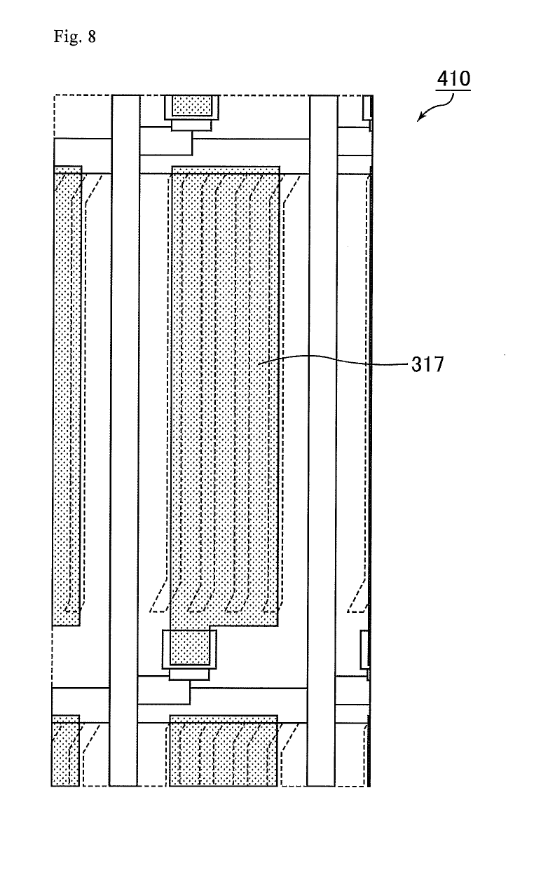

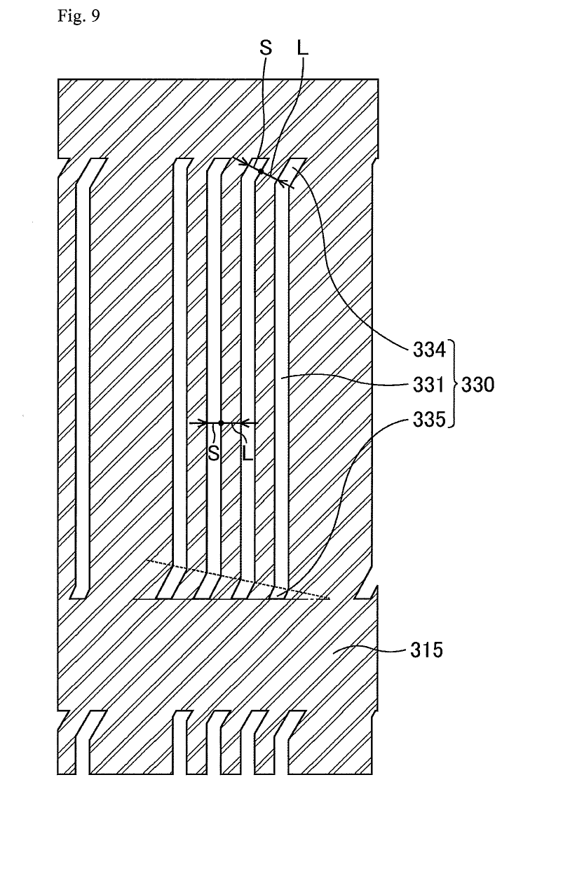

FIG. 8 is a schematic plan view of an active matrix substrate of a FFS-mode liquid crystal display according to a modified example of Embodiment 3. FIG. 9 is a schematic plan view of a common electrode provided on an active matrix substrate of a modified example of Embodiment 3.

In a liquid crystal display 410 according to a modified example of Embodiment 3, as illustrated in FIG. 9, a common electrode 315 is formed to cover most of the display region. The common electrode 315 is formed on a pixel electrode 317 and has plural slits 330 formed in parallel with each other. In addition, the common electrode 315 includes at least one linear portion. As illustrated in FIG. 8, the pixel electrode 317 has no slits therein. The pixel electrode 317 is formed in a plate shape without discontinuities and faces the slits 330.

The slits 330 each include a main portion 331 and auxiliary portions 334 and 335, and have the same shape as the slits 230 formed in the pixel electrode 217 of the liquid crystal display of Embodiment 3. Accordingly, even in the modified example of Embodiment 3, the same effects as those in Embodiment 3 may be exerted. Specifically, the difference between the widths L and S in the region including the main portion 331 and the widths L and S in the regions including the auxiliary portions 334 and 335 is reduced. As a result, change in the slit pattern caused by variation in process is suppressed, enabling improvement in transmittance. Moreover, the widths L and S in the region including the main portion 331 and the widths L and S in the regions including the auxiliary portions 334 and 335 can be substantially the same, respectively.

The present application claims priority to Patent Application No. 2011-175465 filed in Japan on Aug. 10, 2011 under the Paris Convention and provisions of national law in a designated State, the entire contents of which are hereby incorporated by reference.

### Reference Signs List

10: Active matrix substrate
11, 21: Insulating substrate
12: Gate insulator
13, 513: Data bus line
14: First insulating film
15, 315, 515: Common electrode
16a: Second insulating film
16b: Third insulating film
17, 117, 217, 317, 517: Pixel electrode
18, 118, 218, 518: Linear portion
19, 20, 119, 120, 219, 220, 519, 520: Connecting portion
22: Black matrix
23: Color filter
30, 130, 230, 330, 530: Slit
31, 32, 131, 132, 231, 331, 531, 532: Main portion
33, 133, 533: V portion
36, 37, 136, 137: Straight portion
51, 551: Gate bus line
53, 553: TFT (thin film transistor)
54: Semiconductor layer
55a: Gate electrode
55b: Source electrode
55c: Drain electrode
70: Counter substrate
71: Contact hole
80: Liquid crystal layer
110, 210, 310, 410, 510: Liquid crystal display
134, 135, 234, 235, 334, 335, 534, 535: Auxiliary portion

1-7. (canceled)

8. A liquid crystal display comprising:
a first substrate;
a second substrate facing the first substrate; and
a liquid crystal layer that is positioned between the first substrate and the second substrate and contains liquid crystal molecules,
the first substrate including a first electrode, an insulating film provided on the first electrode, and a second electrode provided on the insulating film,
the second electrode having a plurality of slits formed within a pixel,
the first electrode facing the plurality of slits,
the plurality of slits being parallel with each other,
the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion,
a plurality of the first straight portions having the second ends aligned along the same straight line,
on an assumption of a first slit being an endmost slit among the plurality of slits in the pixel,
a slit next to the first slit bending in a manner that the first straight portion and the second straight portion of the slit come closer to the first slit,
a slit more distant from the first slit having a shorter first straight portion,
wherein, when an alignment direction of the liquid crystal molecules under application of no voltage is set as an initial alignment direction,
the first direction and the second direction are each different from the initial alignment direction,
wherein the first direction and the initial alignment direction form an angle larger than an angle formed by the second direction and the initial alignment direction, and
the first straight portion is shorter than the second straight portion.

9. A liquid crystal display comprising:
a first substrate;
a second substrate facing the first substrate; and
a liquid crystal layer that is positioned between the first substrate and the second substrate and contains liquid crystal molecules,
the first substrate including a first electrode, an insulating film provided on the first electrode, and a second electrode provided on the insulating film,
the second electrode having a plurality of slits formed within a pixel,
the first electrode facing the plurality of slits,
the plurality of slits being parallel with each other,
the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion,
a plurality of the first straight portions having the second ends aligned along the same straight line,
on an assumption of a first slit being an endmost slit among the plurality of slits in the pixel,
a slit next to the first slit bending in a manner that the first straight portion and the second straight portion of the slit come closer to the first slit,
a slit more distant from the first slit having a shorter first straight portion,
wherein, when an alignment direction of the liquid crystal molecules under application of no voltage is set as an initial alignment direction,
the first direction and the second direction are each different from the initial alignment direction,
wherein the first direction and the initial alignment direction form an angle of 20° to 40°,
the second direction and the initial alignment direction form an angle of 3° to 10°,
the straight line is a first straight line,
the bent portions of the plurality of slits are aligned along a second straight line, and
the first straight line and the second straight line form an angle of 5° to 15°.

10. A liquid crystal display comprising:
a first substrate;
a second substrate facing the first substrate; and
a liquid crystal layer that is positioned between the first substrate and the second substrate and contains liquid crystal molecules,
the first substrate including a first electrode, an insulating film provided on the first electrode, and a second electrode provided on the insulating film,
the second electrode having a plurality of slits formed within a pixel,
the first electrode facing the plurality of slits,
the plurality of slits being parallel with each other,
the plurality of slits each having a first straight portion that has a first end and a second end and extends in a first direction, a second straight portion that is connected to the first end of the first straight portion and extends in a second direction, and a bent portion bent in a connecting region of the first straight portion and the second straight portion,
a plurality of the first straight portions having the second ends aligned along the same straight line,
on an assumption of a first slit being an endmost slit among the plurality of slits in the pixel,
a slit next to the first slit bending in a manner that the first straight portion and the second straight portion of the slit come closer to the first slit,
a slit more distant from the first slit having a shorter first straight portion,
wherein the plurality of slits each have a third straight portion being connected to the second end of the first straight portion and extending in a third direction, and
the first straight portion and the third straight portion form a V shape.

11. The liquid crystal display according to claim 10,
wherein, when the alignment direction of the liquid crystal molecules under application of no voltage is set as an initial alignment direction,
the third direction and the initial alignment direction form an angle of 20° to 40°,
the plurality of slits each further have a fourth straight portion and a second bent portion, the fourth straight portion being connected to an end of the third straight portion on the side not connected to the first straight portion and extending in a fourth direction, the second bent portion bent in a connecting region of the third straight portion and the fourth straight portion,
the straight line is a first straight line,
the second bent portions of the plurality of slits are aligned along a third straight line,
the first straight line and the third straight line form an angle of 5° to 15°, and
the fourth direction and the initial alignment direction form an angle of 3° to 10°.

12. The liquid crystal display according to claim 8,
wherein the second electrode includes at least three linear portions adjacent to the plurality of slits and a connecting portion connecting the at least three linear portions to each other, and
the first straight portion is adjacent to the connecting portion.

13. The liquid crystal display according to claim 9,
wherein the second electrode includes at least three linear portions adjacent to the plurality of slits and a connecting portion connecting the at least three linear portions to each other, and
the first straight portion is adjacent to the connecting portion.
